(19) United States
(12) Patent Application Publication
(10) Pub. No.: US 2024/0393993 A1
(43) Pub. Date: Nov. 28, 2024

(54) INFORMATION PROCESSING SYSTEM, NON-TRANSITORY COMPUTER READABLE MEDIUM, AND INFORMATION PROCESSING METHOD

(71) Applicant: FUJIFILM BUSINESS INNOVATION CORP., Tokyo (JP)

(72) Inventor: Akira KADODA, Kanagawa (JP)

(73) Assignee: FUJIFILM BUSINESS INNOVATION CORP., Tokyo (JP)

(21) Appl. No.: 18/505,497

(22) Filed: Nov. 9, 2023

(30) Foreign Application Priority Data
May 25, 2023 (JP) 2023-086525

(51) Int. Cl. G06F 3/12

(52) U.S. Cl. CPC G06F 3/1238; G06F 3/1222; G06F 3/1274

(57) ABSTRACT

An information processing system includes one or more processors configured to: accept that a user registers print information serving as a print target, an information processing terminal serving as a transfer destination of the print information, and region information indicating an authorized region that permits the print information to be transmitted to the information processing terminal; and in transferring the registered print information to the registered information processing terminal, transfer the print information to the registered information processing terminal only if the registered information processing terminal is present within the authorized region indicated by the registered region information.

### CROSS-REFERENCE TO RELATED APPLICATIONS

This application is based on and claims priority under 35 USC 119 from Japanese Patent Application No. 2023-086525 filed May 25, 2023.

### BACKGROUND

### (i) Technical Field

The present disclosure relates to an information processing system, a non-transitory computer readable medium, and an information processing method.

### (ii) Related Art

Japanese Unexamined Patent Application Publication No. 2022-160224 discloses a system that manages appropriately a print job depending on the installation location of a printer that performs the print job.

The system includes a cloud service that receives the print job from an information processing apparatus and a printer that is registered in the cloud service. The system includes a first setting unit and a storage unit. The first setting unit sets, in the print job that the cloud service receives from the information processing apparatus, first position information indicating the position where the printer performing the print job is installed. The storage unit stores the print job with the first position information set therein. The system further includes a generating unit and a first transmitting unit. When an acquisition request for a print job list is received from the printer, the generating unit generates the print job list from the print job, stored by the storage unit, using the first position information set in each print job. The first transmitting unit transmits the generated print job list to the printer. The printer includes a second transmitting unit and a controller. The second transmitting unit transmits the acquisition request for the print job list to the cloud service. The controller performs control such that the print job list received from the cloud service is displayed.

Japanese Unexamined Patent Application Publication No. 2010-92133 discloses a print system that appropriately restricts locations where a print job is printed.

The print system includes a print job source terminal, spooler, and printer. The print job source terminal includes a print job issuing unit that issues to the spooler a location-related print job that is related to print-enabled location information representing a location where printing is permitted. The printer includes a print job search requesting unit and a printing unit. The print job search requesting unit issues to the spooler a print job search request including printer location information representing an installation location of the printer. The printing unit executes a print-permitted print job that is permitted to be printed at the installation location of the printer. The spooler includes a print job management unit and a print job searching unit. The print job management unit stores the location-related print job issued from the print job source terminal. In response to the print job search request issued from the printer and in accordance with the printer location information included in the print job search request and the print-enabled location information related to the location-related print job in the print job management unit, the print job searching unit searches the print job management unit for the print-permitted print job and provides the printer with the hit print-permitted print job.

In a contemplated technique of performing printing using print information, the print information may be registered in a cloud server, the print information may be transferred from the cloud server to an information processing terminal, such as a specified mobile terminal, and the information processing terminal may transmit the print information to an image forming apparatus.

This technique may be beneficial because the image forming apparatus not connected to the cloud server may also perform specific operations, which are typically executed by the cloud server, such as log management, permission operation, or confidential operation.

According to the technique, however, any specified information processing terminal may perform printing and, if the registered print information is performed, there is a possibility of information leak.

### SUMMARY

Aspects of non-limiting embodiments of the present disclosure relate to providing an information processing system, non-transitory computer readable medium, and information processing method reducing the possibility of information leak in printing performed in accordance with registered print information in comparison with the case in which a region which permits print information to be transferred to is not limited to a pre-registered authorized region.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including one or more processors configured to: accept that a user registers print information serving as a print target, an information processing terminal serving as a transfer destination of the print information, and region information indicating an authorized region that permits the print information to be transmitted to the information processing terminal; and in transferring the registered print information to the registered information processing terminal, transfer the print information to the registered information processing terminal only if the registered information processing terminal is present within the authorized region indicated by the registered region information.

### BRIEF DESCRIPTION OF THE DRAWINGS

Exemplary embodiment of the present disclosure will be described in detail based on the following figures, wherein:

FIG. 1 illustrates a configuration example of an information processing system of an exemplary embodiment of the disclosure;

FIG. 2 illustrates an electrical configuration example of a cloud server of the exemplary embodiment of the disclosure;

FIG. 3 is a block diagram illustrating an electrical configuration example of a client computer of the exemplary embodiment of the disclosure;

FIG. 4 is a block diagram illustrating an electrical configuration example of an information processing terminal of the exemplary embodiment of the disclosure;

FIG. 5 schematically illustrates a process performed by the information processing system of the exemplary embodiment of the disclosure;

FIG. 6 illustrates a process flow from registering the information processing terminal to a print management system to starting using the information processing terminal in accordance with the exemplary embodiment of the disclosure;

FIG. 7 illustrates an example of a registration screen used when the information processing terminal of the exemplary embodiment of the disclosure is registered on the print management system;

FIG. 8 illustrates the registration of a print job on the print management system of the exemplary embodiment of the disclosure;

FIG. 9 illustrates an example of a print setting screen used when the information processing terminal at a spool destination is set on a print tool of the client computer of the exemplary embodiment of the disclosure;

FIG. 10 illustrates an example of a process flow that is performed until the print job registered on the print management system of the exemplary embodiment of the disclosure is spooled on the information processing terminal;

FIG. 11 illustrates a screen example that is displayed during and after the spooling on the information processing terminal of the exemplary embodiment of the disclosure;

FIG. 12 illustrates a process flow until the print job spooled on the information processing terminal of the exemplary embodiment of the disclosure is transmitted to an image forming apparatus;

FIG. 13 illustrates an example of a print job list screen of the exemplary embodiment of the disclosure;

FIG. 14 illustrates an example of a spooled state of the print job in the information processing system of the exemplary embodiment of the disclosure;

FIG. 15 illustrates a process of the information processing system of the exemplary embodiment of the disclosure performed if authorized regions are regions of multiple floors of a building;

FIG. 16 is a functional block diagram illustrating the information processing system of the exemplary embodiment of the disclosure;

FIG. 17 schematically illustrates a structure example of an authorized region information database of the exemplary embodiment of the disclosure;

FIG. 18 is a flowchart illustrating an example of a registration process of the exemplary embodiment of the disclosure;

FIG. 19 is a front view illustrating a configuration example of an authorized region input screen of the exemplary embodiment of the disclosure;

FIG. 20 is a flowchart illustrating an example of a server-side information processing process of the exemplary embodiment of the disclosure;

FIG. 21 is a flowchart illustrating an example of a terminal-side information processing process of the exemplary embodiment of the disclosure; and

FIG. 22 schematically illustrates an example of an overall process flow of the information processing system of the exemplary embodiment of the disclosure.

### DETAILED DESCRIPTION

Exemplary embodiment of the disclosure is described in detail with reference to the drawings.

An information processing system 1 of the exemplary embodiment of the disclosure includes a cloud server, image forming apparatus, client computer, and information processing apparatus interconnected to each other via communication networks, including a variety of type of networks.

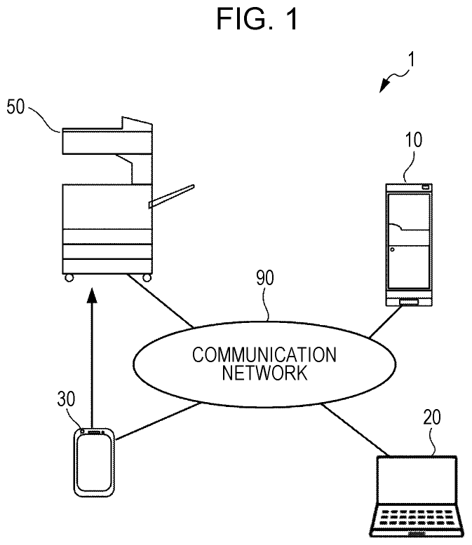

The information processing system 1 of the exemplary embodiment is described below with reference to FIG. 1. FIG. 1 illustrates a configuration example of the information processing system 1 of the exemplary embodiment.

Referring to FIG. 1, the information processing system 1 of the exemplary embodiment includes a cloud server 10, client computer 20, information processing terminal 30, and image forming apparatus 50. The cloud server 10, client computer 20, and image forming apparatus 50 are interconnected to each other via a communication network 90, such as a local-area network (LAN), wide-area network (WAN), Internet, and/or intranet. The cloud server 10, client computer 20, information processing terminal 30, and image forming apparatus 50 exchange a variety of data with each other via the communication network 90. According to the exemplary embodiment, the image forming apparatus 50 forms an image in response to a print instruction when the client computer 20 or information processing terminal 30 provides the print instruction to the image forming apparatus 50 via the cloud server 10.

For convenience of explanation, FIG. 1 illustrates a single cloud server 10, single client computer 20, single information processing terminal 30, and single image forming apparatus 50. Alternatively, multiple apparatuses of at least one of these types may be employed. The information processing system 1 of the exemplary embodiment may not only provide a print instruction from the information processing terminal 30 via the communication network 90 and but also provide the print instruction via near field communication, such as Wi-Fi (registered trademark) or Bluetooth (registered trademark).

An example of the cloud server 10 and the client computer 20 may be an information processing apparatus, such as a personal computer and a server computer. An example of the information processing terminal 30 may be a mobile phone, such as a smart phone, or a variety of mobile devices, such as a personal digital assistant (PDA) or a notebook computer.

According to the exemplar embodiment, the image forming apparatus 50 may be a digital multi-function apparatus having an image printing function, image reading function, and image transmission function. The image forming apparatus 50 is not limited to such an apparatus. For example, the image forming apparatus 50 may be an image forming apparatus having only the image printing function, or an image forming apparatus having the image printing function and the image reading function.

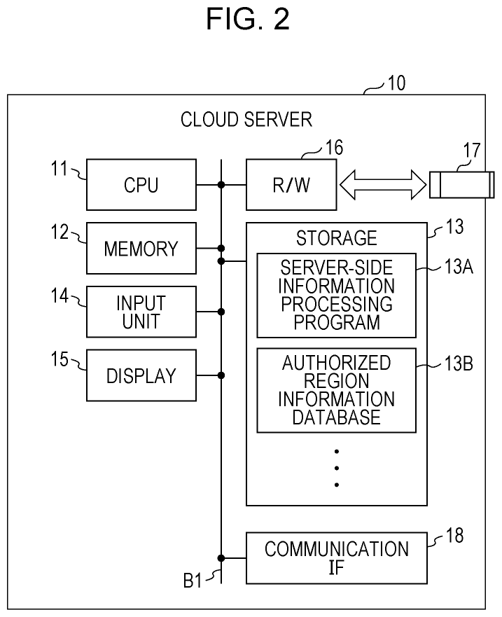

The configuration of the cloud server 10 of the exemplary embodiment is described with reference to FIG. 2. FIG. 2 illustrates an electrical configuration example of the cloud server 10 of the exemplary embodiment.

Referring to FIG. 2, the cloud server 10 of the exemplary embodiment includes a central processing unit (CPU) 11, serving as a processor, memory 12 serving as a temporary memory region, non-volatile storage 13, input unit 14, such as a keyboard and a mouse, display 15, such as a liquid-crystal display, medium reader/writer (R/W) 16, and communication IF (interface) 18. The CPU 11, memory 12, storage 13, input unit 14, display 15, medium reader/writer 16, and communication IF 18 are interconnected to each other via a bus B1. The medium reader/writer 16 reads information written on a recording medium 17 and writes information onto the recording medium 17.

The storage 13 of the exemplary embodiment may be implemented by a hard-disk drive (HDD), solid-state drive (SSD), or flash memory. The storage 13 as a recording medium stores a server-side information processing program 13A. The server-side information processing program 13A is stored (installed) onto the storage 13 when the recording medium 17 having the server-side information processing program 13A recorded thereon is connected to the medium reader/writer 16 and the medium reader/writer 16 reads the server-side information processing program 13A from the recording medium 17. The CPU 11 reads the server-side information processing program 13A from the storage 13 as appropriate and loads the server-side information processing program 13A on the memory 12 and then executes each process of the server-side information processing program 13A.

The storage 13 also stores an authorized region information database 13B. The authorized region information database 13B is described below in greater detail.

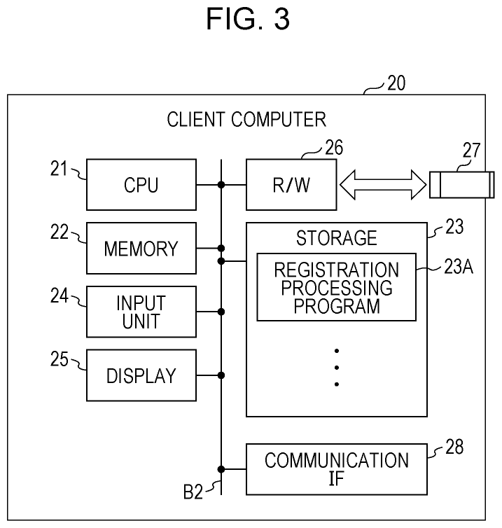

The configuration of the client computer 20 of the exemplary embodiment is described with reference to FIG. 3. FIG. 3 is a block diagram illustrating an electrical configuration example of the client computer 20 of the exemplary embodiment.

Referring to FIG. 3, the client computer 20 of the exemplary embodiment includes a CPU 21, serving as a processor, memory 22 serving as a temporary memory region, non-volatile storage 23, input unit 24, such as a keyboard and a mouse, display 25, such as a liquid-crystal display, medium reader/writer 26, and communication IF 28. The CPU 21, memory 22, storage 23, input unit 24, display 25, medium reader/writer 26, and communication IF 28 are interconnected to each other via a bus B2. The medium reader/writer 26 reads information written on a recording medium 27 and writes information onto the recording medium 27.

The storage 23 of the exemplary embodiment may be implemented by an HDD, SSD, or flash memory. The storage 23 as a recording medium stores a registration processing program 23A. The registration processing program 23A is stored on the storage 23 when the recording medium 27 having the registration processing program 23A recorded thereon is connected to the medium reader/writer 26 and the medium reader/writer 26 reads the registration processing program 23A from the recording medium 27. The CPU 21 reads the registration processing program 23A from the storage 23 as appropriate and loads the registration processing program 23A on the memory 22 and then executes each process of the registration processing program 23A.

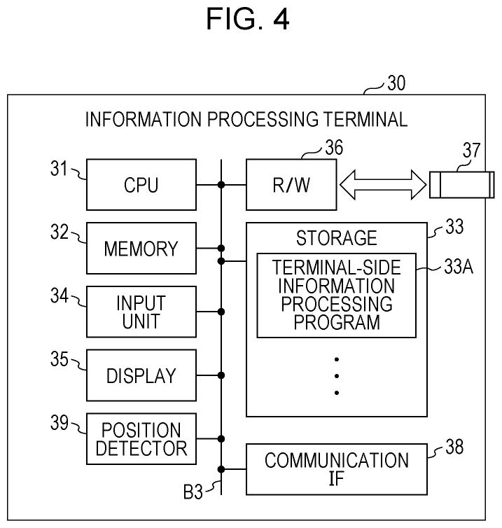

The configuration of the information processing terminal 30 of the exemplary embodiment is described with reference to FIG. 4. FIG. 4 is a block diagram illustrating an electrical configuration example of the information processing terminal 30 of the exemplary embodiment.

Referring to FIG. 4, the information processing terminal 30 of the exemplary embodiment includes a CPU 31, serving as a processor, memory 32 serving as a temporary memory region, non-volatile storage 33, input unit 34, such as a keyboard and a mouse, display 35, such as a liquid-crystal display, medium reader/writer 36, communication IF 38, and position detector 39. The CPU 31, memory 32, storage 33, input unit 34, display 35, medium reader/writer 36, communication IF 38, and position detector 39 are interconnected to each other via a bus B3. The medium reader/writer 36 reads information written on a recording medium 37 and writes information onto the recording medium 37.

The storage 33 of the exemplary embodiment may be implemented by a HDD, SSD, or flash memory. The storage 33 as a recording medium stores a terminal-side information processing program 33A. The terminal-side information processing program 33A is stored onto the storage 23 when the recording medium 37 having the terminal-side information processing program 33A recorded thereon is connected to the medium reader/writer 36 and the medium reader/writer 36 reads the terminal-side information processing program 33A from the recording medium 37. The CPU 31 reads the terminal-side information processing program 33A from the storage 33 as appropriate and loads the terminal-side information processing program 33A on the memory 32 and then executes each process of the terminal-side information processing program 33A.

The position detector 39 of the exemplary embodiment detects the position of the information processing terminal 30 in a horizontal direction using the global positioning system (GPS) and the position of the information processing terminal 30 in a height direction using Pinnacle/Metropolitan Beacon System (MBS). The position detector 39 is not limited to this system. For example, a device able to detect a position in the height direction using GPS may be used to detect a position of the information processing terminal 30 in three-dimensional directions using GPS alone and may thus be applied to the position detector 39.

In the information processing system 1 of the exemplary embodiment, the cloud server 10 provides, as a cloud service, a print management system including the image forming apparatus 50 that performs printing by performing specific operations on a print job. The specific operations include a log management operation that manages a log of the print job, a permission operation that permits the print job to be performed, and a confidential operation that masks a confidential portion of the print job. In the print management system, the cloud server 10 receives the print job from the client computer 20, performs the permission operation on the received print job, and then transmits the permitted print job to the image forming apparatus 50. In this way, the image forming apparatus 50 performs printing only in accordance with a permitted print job. The term “print job” refers to a process unit of printing operation executed in response to one instruction from an operator.

If the image forming apparatus 50 not connected to the information processing system 1 or not permitted to be connected to the information processing system 1 attempts to perform printing, a specific operation available on the information processing system 1 may not be usable.

The information processing system 1 of the exemplary embodiment receives a print job including print information and serving as a print target, performs a specific operation on the print information included in the received print job, and transmits the print job including the print information having undergone the specific operation to the information processing terminal 30 instead of directly transmitting the print job to the image forming apparatus 50.

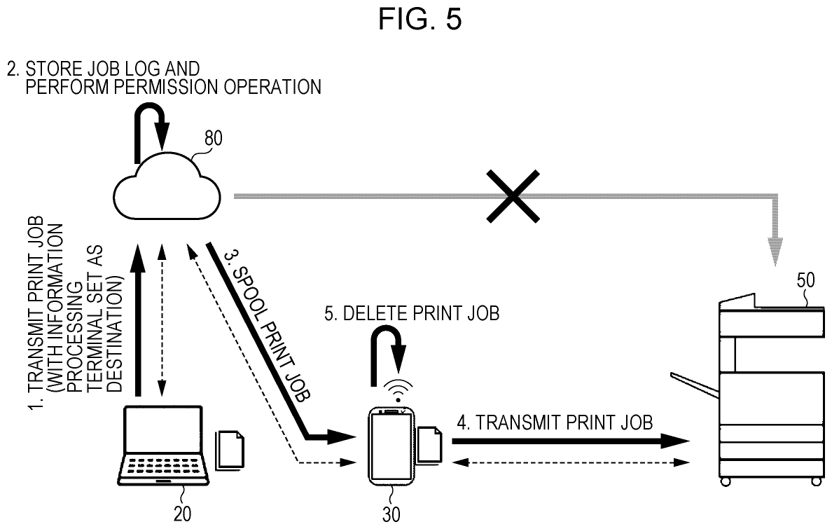

Specifically, referring to FIG. 5, the client computer 20 or the information processing terminal 30 transmits the print job to the print management system 80 over a cloud with the destination of the print job set to the information processing terminal 30. FIG. 5 schematically illustrates the process performed by the information processing system 1 of the exemplary embodiment.

The print management system 80 receives the print job and performs the specific operation including storing a job log managing a log and performing a permission operation on printing. For example, the permission operation may be performed by requesting permission from a pre-registered client computer 20 to print the print job and by receiving permission results.

The print management system 80 transmits the print job having undergone the specific operation to an information processing terminal 30 serving as a destination specified by the client computer 20 or information processing terminal 30 and then spools the print job on the information processing terminal 30 serving as the destination. The term “spool” refers to “temporarily storing the print information at a different location” rather than “directly transmitting the print information to the image forming apparatus 50.”

When the information processing terminal 30 transmits the spooled print job to the image forming apparatus 50 via the near field communication, the image forming apparatus 50 is caused to perform printing in accordance with the print job having undergone the specific operation. In this way, even the image forming apparatus 50 not connected to the information processing system 1 or not permitted to be connected to the information processing system 1 may perform the printing using the specific operation available on the information processing system 1. According to the exemplary embodiment, the information processing terminal 30 transmits the print job to the image forming apparatus 50 via the near field communication. However, the communication is not limited to the near field communication. For example, the print job may be transmitted via the communication network 90 or directly transmitted to the image forming apparatus 50 via a wired communication link.

The basic method of performing the printing on the image forming apparatus 50 by spooling the print job on the information processing terminal 30 is specifically described.

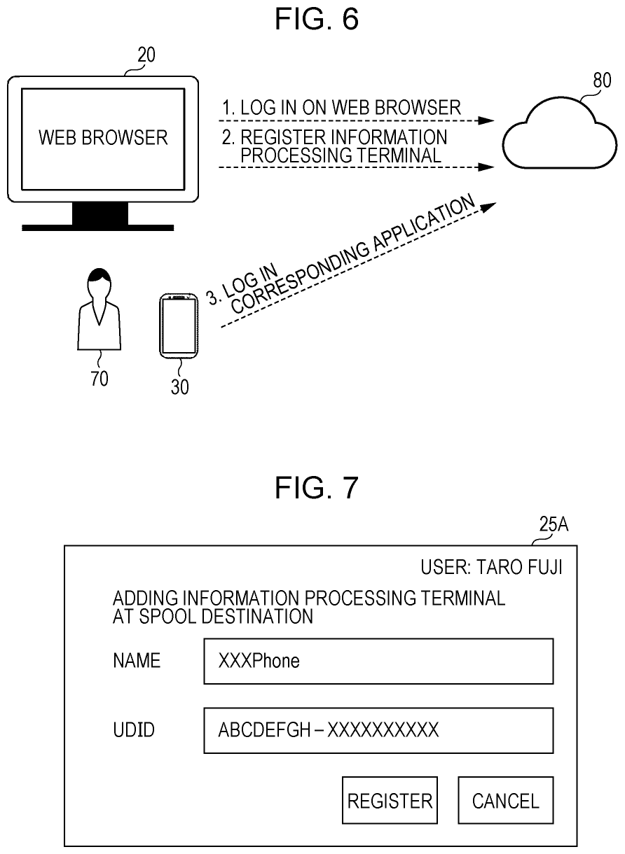

A process flow from registering the information processing terminal 30 to the print management system 80 to starting using the print management system 80 is described below. FIG. 6 illustrates the process flow from registering the information processing terminal 30 to the print management system 80 to starting using the print management system 80.

In the information processing system 1 of the exemplary embodiment, a user 70 logs in on the print management system 80 through a web browser via the client computer 20 or the information processing terminal 30 used by the user 70 and registers the information processing terminal 30 used by the user 70.

Information used to register the information processing terminal 30 may include information uniquely identifying the information processing terminal 30, such as unique device identifier (UDID), serial number, international mobile equipment identity (IMEI) number, or media access control (MAC) address.

The user 70 installs an application supporting the information processing terminal 30 (hereinafter referred to as “support application”) and then logs in on the print management system 80. This leads to the state in which the print job is ready to be spooled on the registered information processing terminal 30.

When the information processing terminal 30 is registered, a registration screen 25A illustrated in FIG. 7 is displayed and the registration of the information processing terminal 30 may thus be accepted. FIG. 7 illustrates an example of the registration screen 25A used to register the information processing terminal 30 on the print management system 80.

In the example of the registration screen 25A in FIG. 7, “XXXPhone” is entered as the name of the information processing terminal 30 and “ABCDEFGH-XXXXXXXXXX” is entered as UDID. The information processing terminal 30 is registered on the print management system 80 by selecting a register button in FIG. 7. Selecting a cancel button cancels the registration of the information processing terminal 30.

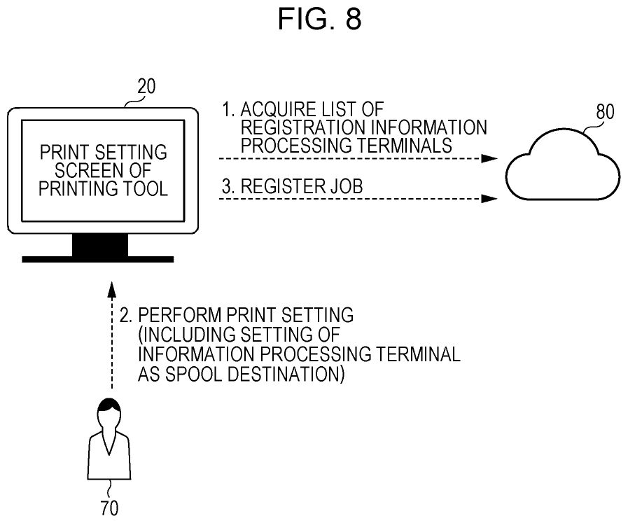

An example of how the print job is registered on the print management system 80 is described below. FIG. 8 illustrates the registration of the print job on the print management system 80.

The information processing system 1 of the exemplary embodiment registers the print job using a print tool including a web user interface (UI) or a printer driver supporting cloud printing.

Specifically, when a print setting screen of the print tool, such as the printer driver or the web UI, a list of the information processing terminals 30 serving as a spool destination corresponding to the user 70 having logged on the print management system 80 is downloaded and thus obtained from the print management system 80.

The user 70 registers the print job (for “job registration”) by specifying an information processing terminal 30 as the spool destination from the list of the information processing terminals 30. In specifying the information processing terminal 30 as the spool destination, all the information processing terminals 30 of the user 70 may be selected or any information processing terminal 30 specified by the user 70 may be selected.

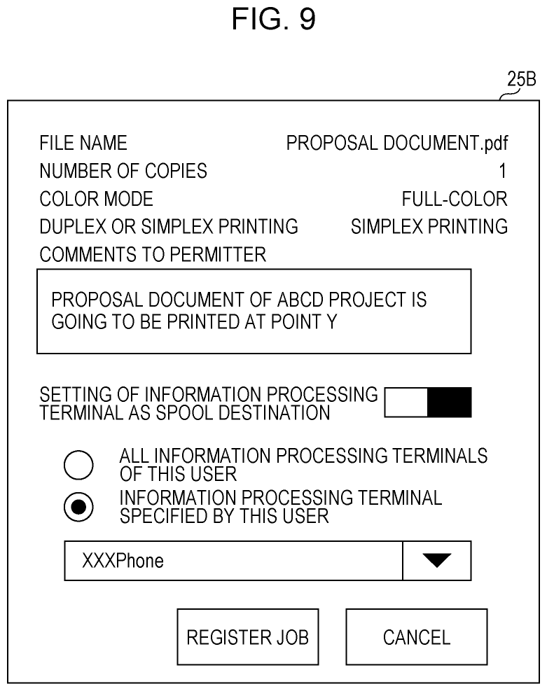

FIG. 9 illustrates an example of a print setting screen 25B used when the information processing terminal 30 at a spool destination is set on a print tool of the client computer 20.

The print setting screen 25B in FIG. 9 illustrates a file name “Proposal document.pdf.” number of copies “1,” color mode “Full color,” and duplex or simplex printing “simplex.” The print setting screen 25B in FIG. 9 also illustrates permitter's comments “Proposal document ABCD Project is going to be printed at Point Y.” In the print setting screen 25B in FIG. 9, the setting of the information processing terminal 30 as the spool destination is set to be effective, “Information processing terminal specified by this user” is selected, and “XXXPhone” is selected as the specified information processing terminal 30. Selecting the register job button in FIG. 9 causes the print job to be registered on the print management system 80. If the cancel button is selected, the registration of the print job is canceled.

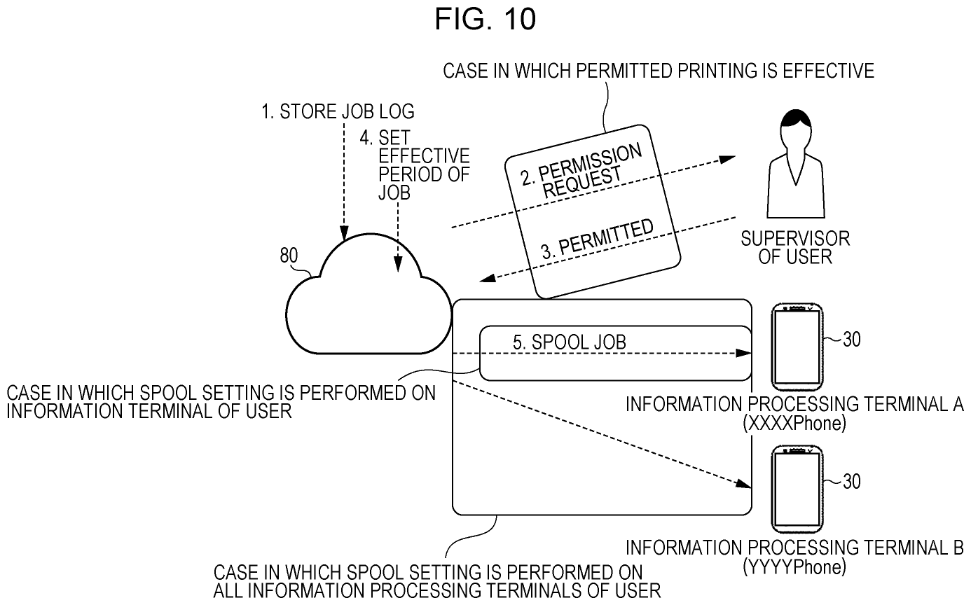

A process flow that is performed until the print job registered on the print management system 80 is spooled on the information processing terminal 30 is described below. FIG. 10 illustrates an example of the process flow that is performed until the print job registered on the print management system 80 is spooled on the information processing terminal 30. In the following discussion, the specific operations include the log management operation, permission operation, and effective period setting operation that sets the effective period of the print job.

When the print job is registered on the print management system 80, the print management system 80 over the cloud stores a job log, performs print permission by making a permission request, sets the effective period of the print job, and then spools the print job on the information processing terminal 30. As illustrated more in detail in FIG. 10, the print management system 80 stores the job log and performs the permission operation if the permitted printing is effective. Specifically, the print management system 80 transmits the permission request to the client computer 20 used by the supervisor of the user 70 and then receives the permission results responsive to the print job. The print job is permitted after the permission results are received, the print management system 80 sets the effective period of the print job. A predetermined period may be set as the effective period. For example, a period for the permitted printing or a default period may be beforehand set as the predetermined period and then the effective period may be determined from the predetermined period.

After all the operations are complete, the print job is spooled on the information processing terminal 30 as the spool destination specified during the job registration. FIG. 10 illustrates the case of the transmission to the information processing terminal 30 specified by the user 70 where the print job is spooled on the information processing terminal A (XXXXPhone) and the case of the transmission to all the information processing terminals 30 of the user 70 where the print job is spooled on the information processing terminal A (XXXXPhone) and information processing terminal B (YYYYPhone).

The structure of the spooled print job includes “print information” and “attribute information of the print information” and these pieces of information is collectively referred as the print job. The attribute information includes print setting information managed separately from the print information and information indicating the effective period of the print job.

The spooling of the print job may be performed in the way in which the cloud transmits the print job to the information processing terminal 30 in a push method or in the way in which the information processing terminal 30 receives the print job at any timing of the user 70 in a pull method.

In the case where the information processing terminal 30 performs the printing at another point or a destination, an output destination may not necessarily be the image forming apparatus 50 of the user's own company. For this reason, the print job is converted into a predetermined common format and then spooled on the information processing terminal 30 such that the printing is performed regardless of the type of the image forming apparatus 50. The common format may be portable document format (PDF) or Mopria. The print job is thus converted to the format common to a variety of companies and then spooled on the information processing terminal 30.

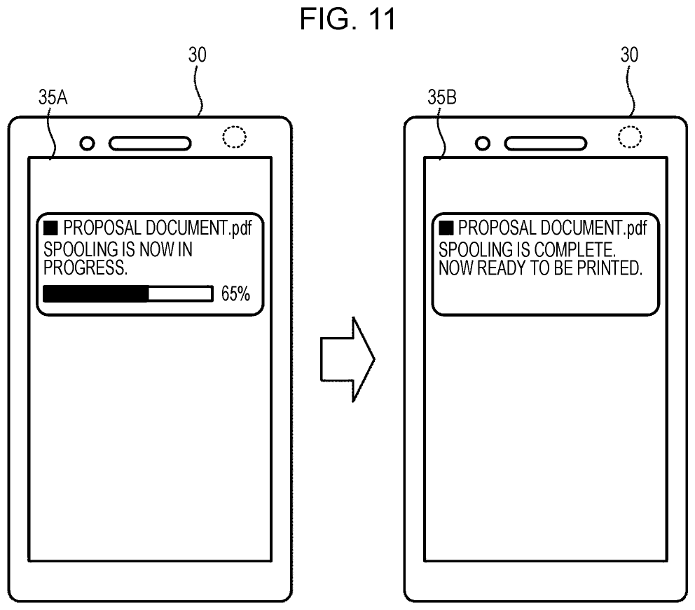

FIG. 11 illustrates a screen example of the progress screen 35A that is displayed in the middle of the spooling of the print job on the information processing terminal 30 and a screen example of the spool completion screen 35B that is displayed after the completion of the spooling.

When the print job is spooled on the information processing terminal 30, a progress status with the spooling in progress is displayed on the progress screen 35A in FIG. 11. The progress screen 35A in FIG. 11 indicates that the print job of “Proposal document.pdf” is being spooled with 65% of the spooling completed. When the spooling is complete, the spool completion screen 35B is displayed. The spool completion screen 35B in FIG. 11 indicates that the spooling of the print job of “Proposal document.pdf” is complete and the printing is ready to be started.

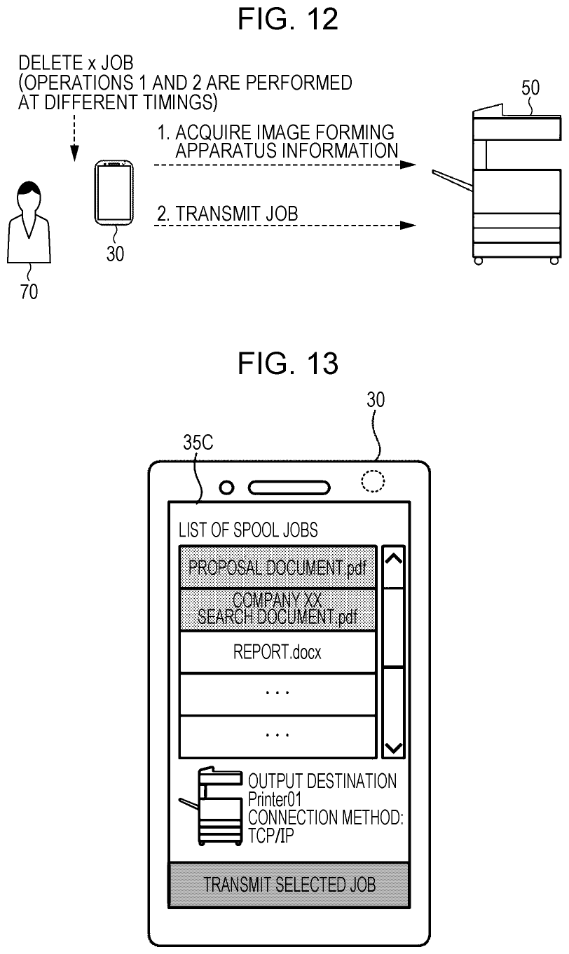

A process flow until the print job spooled on the information processing terminal 30 is transmitted to the image forming apparatus 50 is described below. FIG. 12 illustrates the process flow until the print job spooled on the information processing terminal 30 is transmitted to the image forming apparatus 50.

The support application of the information processing terminal 30 is started up. As illustrated in FIG. 12, an Internet protocol (IP) address of the image forming apparatus 50 serving as a connection destination is acquired and set to transmit the print job to the image forming apparatus 50.

Information used to connect to the image forming apparatus 50 may be manually set by the user 70, or may be set by near field communication (NFC) touching on the image forming apparatus 50 or by reading quick response (QR) code.

The print job may be transmitted in response to an operation performed by the user 70. Referring to FIG. 13, in accordance with the support applications of the information processing terminal 30, the user 70 transmits the print job to the image forming apparatus 50 by displaying a print job list screen 35C listing spooled print jobs, selecting a print job to be printed, and then selecting a transmit button. FIG. 13 illustrates an example of the print job list screen 35C displaying the spooled print jobs. Referring to FIG. 13, two print jobs, “Proposal document.pdf” and “Company XX search document,” are selected and other documents including “Report.docx” remain unselected.

The support application of the information processing terminal 30 periodically checks the effective period of each spooled print job in accordance with the attribute information and deletes a print job if the effective period of the print job has expired regardless of whether the print job has been transmitted to the image forming apparatus 50.

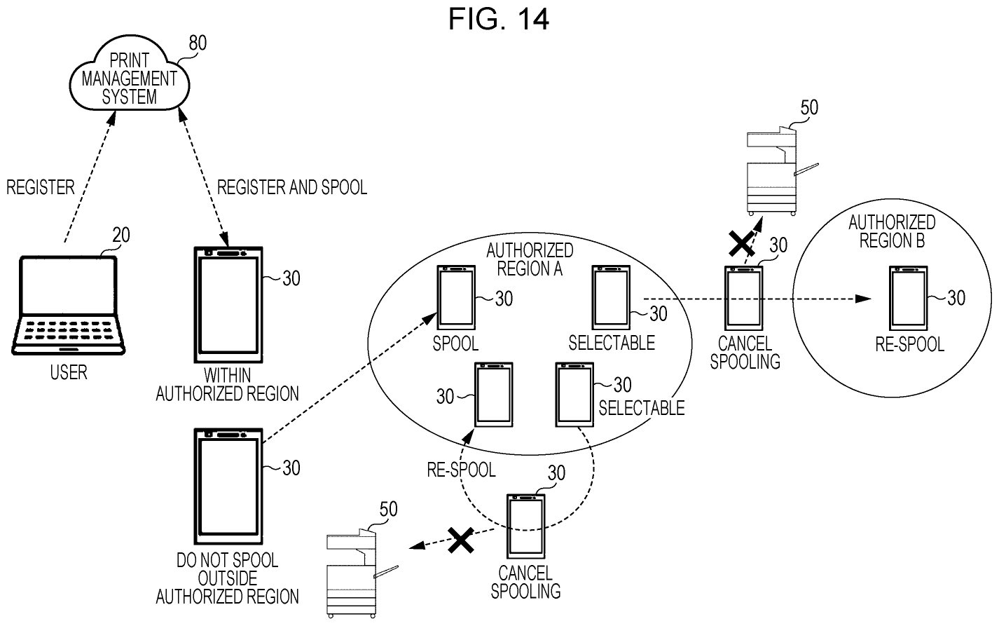

The flow process of the information processing system 1 of the exemplary embodiment has been described. In the information processing system 1, a region that permits the spooling of the print job from the print management system 80 (the cloud server 10) to the information processing terminal 30 to be performed is limited an authorized region. FIG. 14 illustrates an example of a spooled state of the print job in the information processing system 1 of the exemplary embodiment.

In the information processing system 1 of the exemplary embodiment as previously described, the client computer 20 or information processing terminal 30 uploads the print job to the print management system 80 as illustrated in FIG. 14. However, in the information processing system 1, information processing terminals 30 that accept the spooling of the print job from the print management system 80 are limited to an information processing terminal 30 that is present within a predetermined authorized region. This may lead to reducing the possibility of information leak of the print job in comparison with the case in which the print job is unconditionally spooled to the information processing terminal 30.

Referring to FIG. 14, after being outside the authorized region and thus not serving as a spool target, the information processing terminal 30 moves into an authorized region A thereby becoming a spool target.

The information processing terminal 30 may temporarily move out of the authorized region A and then again move back into the authorized region A. At the moment when the information processing terminal 30 moves out of the authorized region A, the spooled job is deleted and the image forming apparatus 50 is unable to perform the printing in accordance with the print job. In this case, however, when the information processing terminal 30 returns to the authorized region A again, the print job is spooled again and the printing in accordance with the print job may be enabled.

Similarly, if the information processing terminal 30 moves out of the authorized region A and then goes to an authorized region B, the image forming apparatus 50 is unable to print temporarily. When the information processing terminal 30 arrives at the authorized region B, the print job is spooled again and the printing in accordance with the print job is enabled.

The information processing system 1 of the exemplary embodiment is applicable to not only a region in a horizontal direction but also a region in a height direction serving as a target authorized region. The position detector 39 of the exemplary embodiment is thus enabled to detect not only a position of the information processing terminal 30 in the horizontal direction but also a position of the information processing terminal 30 in the height direction.

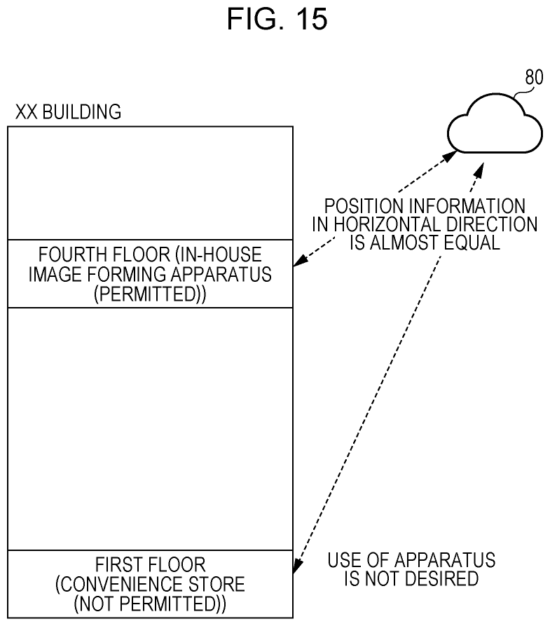

FIG. 15 illustrates a multi-floor building. For example, an image forming apparatus 50 installed on one floor (a convenience store on the first floor in FIG. 15) is disabled from printing while another image forming apparatus 50 installed on another floor (in internal spacing on the fourth floor in FIG. 15) is enabled to print. FIG. 15 illustrates a process of the information processing system 1 of the exemplary embodiment performed if authorized regions are regions of multiple floors of the building.

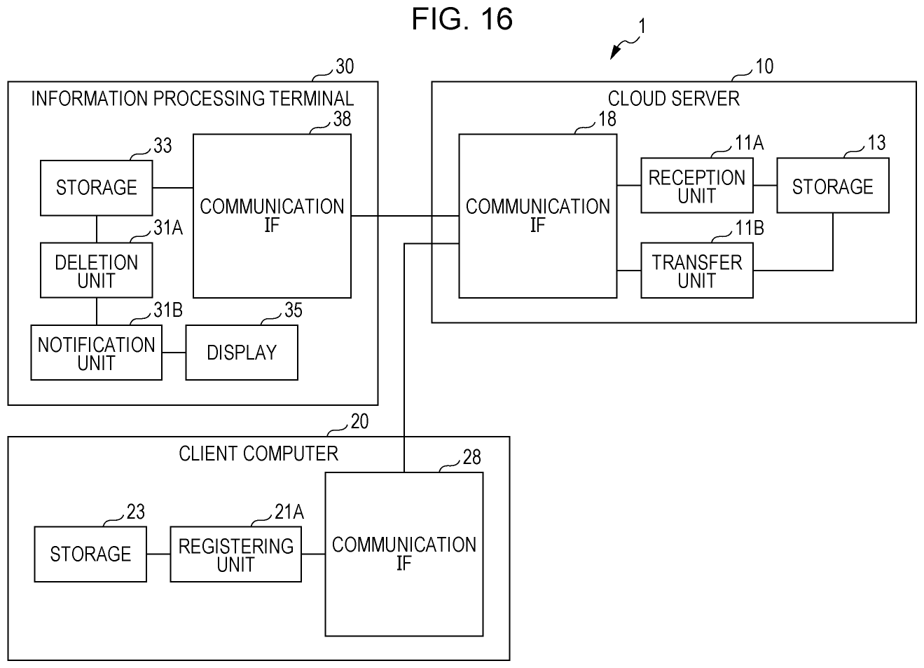

Referring to FIG. 16, spooling limited to the authorized region may be performed in an example of a functional configuration of the information processing system 1 of the exemplary embodiment. FIG. 16 is a functional block diagram illustrating the information processing system 1 of the exemplary embodiment.

Referring to FIG. 16, the cloud server 10 of the exemplary embodiment includes a reception unit 11A and transfer unit 11B, the client computer 20 includes a registration unit 21A, and the information processing terminal 30 includes a deletion unit 31A and notification unit 31B. The CPU 11 in the cloud server 10 operates as the reception unit 11A and transfer unit 11B by executing the server-side information processing program 13A. The CPU 21 in the client computer 20 operates as the registration unit 21A by executing the registration processing program 23A. The CPU 31 in the information processing terminal 30 in the information processing terminal 30 operates as the deletion unit 31A and notification unit 31B by executing the terminal-side information processing program 33A.

The reception unit 11A of the exemplary embodiment accepts the registration performed by the user. In the registration, the user registers the print information serving a print target, the information processing terminal 30 serving as a transfer destination of the print information, and the authorized region where the transfer (namely, spooling) to the information processing terminal 30 is permitted. In the transfer of the registered print information to the registered information processing terminal 30, the transfer unit 11B of the exemplary embodiment spools (transfers) the print information to the information processing terminal 30 only if the information processing terminal 30 is present within the authorized region indicated by the registered region information.

The deletion unit 31A of the exemplary embodiment deletes the transferred print information when the information processing terminal 30 has moved out of the authorized region. The notification unit 31B of the exemplary embodiment notifies the user of information indicating the print information has been deleted.

The information processing terminal 30 may enter again the authorized region after leaving the authorized region. In such a case, the transfer unit 11B of the exemplary embodiment transfers the print information again to the information processing terminal 30. As described with reference to FIG. 14, the authorized region before leaving and the authorized region the information processing terminal 30 has entered may be the same authorized region or different authorized regions.

The transfer unit 11B of the exemplary embodiment may make restrictions in accordance with the authorized region only when the print information is a confidential document. The reception unit 11A of the exemplary embodiment receives the registration of the authorized region on a per user basis. According to the exemplary embodiment, the reception of the region information is performed on a per user basis. The disclosure is not limited to this method. The region information may be received on a per group basis with each including multiple persons. In such a case, the groups may be a group including persons belonging to the same company, a group including persons belonging to the same office, or a group including persons belonging to the same department of the company.

In the information processing system 1 of the exemplary embodiment, the attribute information includes information (hereinafter referred to as “confidential designation information”) indicating whether the print information is information indicating a confidential document. The disclosure is not limited to this setting.

As previously described, in the information processing system 1 of the exemplary embodiment, the authorized region is defined by three-dimensional directions, including the horizontal direction and the height directions. The disclosure is not limited to this setting. The authorized region may be defined by only one of the horizontal direction and the height direction.

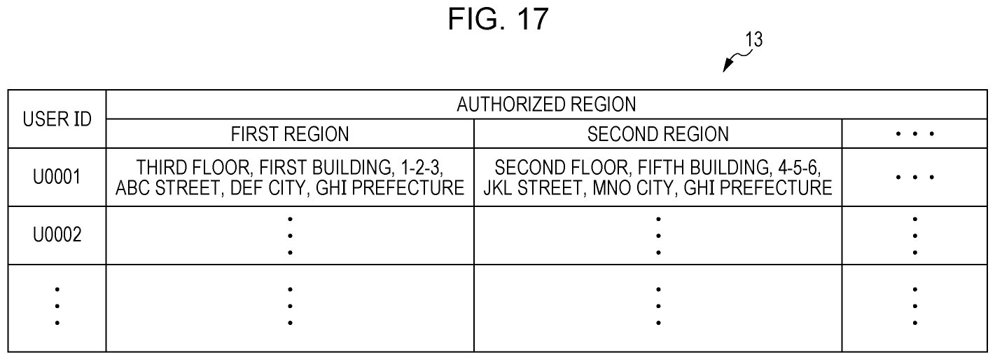

The authorized region information database 13B of the exemplary embodiment is described with reference to FIG. 17. FIG. 17 schematically illustrates a structure example of the authorized region information database 13B of the exemplary embodiment.

In the region information is registered on the authorized region information database 13B, a variety of information including user identification (ID) and the authorized region is associated and stored as illustrated in FIG. 17.

The user ID is different from user to user and pre-assigned to each user to identify each user of the information processing system 1. The authorized region is information indicating the authorized region itself and multiple pieces of information may be registered on each user in the information processing system 1 of the exemplary embodiment as illustrated in FIG. 17.

In the information processing system 1 illustrated in FIG. 17, the region information may include information about an address specifying the name of a building serving as a target and a floor number serving as a target. The disclosure is not limited to this setting. For example, the authorized region may be specified using information indicating latitude, longitude, and height. In one example in which the authorized region is specified using latitude and longitude, the position of the outer line of the authorized region may be specified by latitude and longitude. In another example in which the authorized region is specified using latitude and longitude, the authorized region may be a circle in a plan view, the center of the circle may be specified by latitude and longitude with the radius or the diameter of the circle specified.

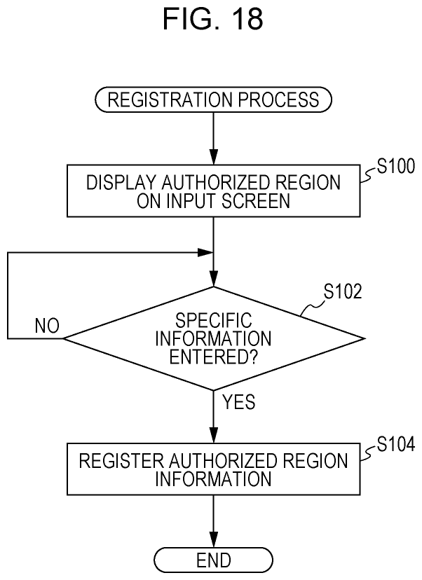

Function of the information processing system 1 of the exemplary embodiment limiting to the authorized region the spooling of the print job to the information processing terminal 30 is described with reference to FIGS. 18 through 22.

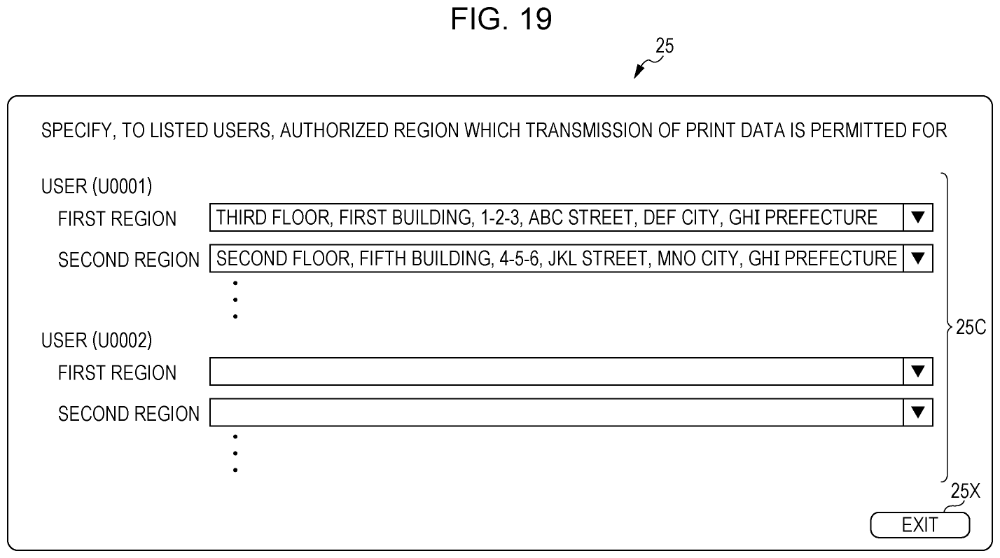

A function of the client computer 20 that performs a registration process of registering the region information indicating the authorized region onto the authorized region information database 13B is described with reference to FIGS. 18 and 19. FIG. 18 is a flowchart illustrating an example of the registration process of the exemplary embodiment. The CPU 21 in the client computer 20 performs the registration process in FIG. 18 by executing the registration processing program 23A when the administrator of the client computer 20 (supervisor of the user 70 in the disclosure) instructs the registration process to be performed.

In step S100 in FIG. 18, the CPU 21 controls the display 25 to display an authorized region input screen having a predetermined form. In step S102, the CPU 21 waits on standby until predetermined information is entered. FIG. 19 illustrates an example of the authorized region input screen of the exemplary embodiment.

The authorized region input screen of the exemplary embodiment displays a message prompting each user 70 of the registered information processing terminal 30 to enter an authorized region as illustrated in FIG. 19. The authorized region input screen also displays an authorized region input area 25C that receives the authorized region of each user 70.

When the authorized region input screen in FIG. 19 is displayed, the administrator enters, via the input unit 24, the authorized region in the authorized region input area 25C corresponding to the user 70 for which the administrator wants to set the authorized region. When all the authorized regions specified by the administrator are entered, the administrator selects an exit button 25X using the input unit 24. When the exit button 25X is selected by the administrator, the yes path is followed in step S102 and the process proceeds to step S104.

In step S104, the CPU 21 stores (registers), in a memory region corresponding to the authorized region information database 13B, the region information indicating all the authorized regions entered by the administrator on the authorized region input screen and then ends the registration process.

The registration process constructs the authorized region information database 13B illustrated in FIG. 17.

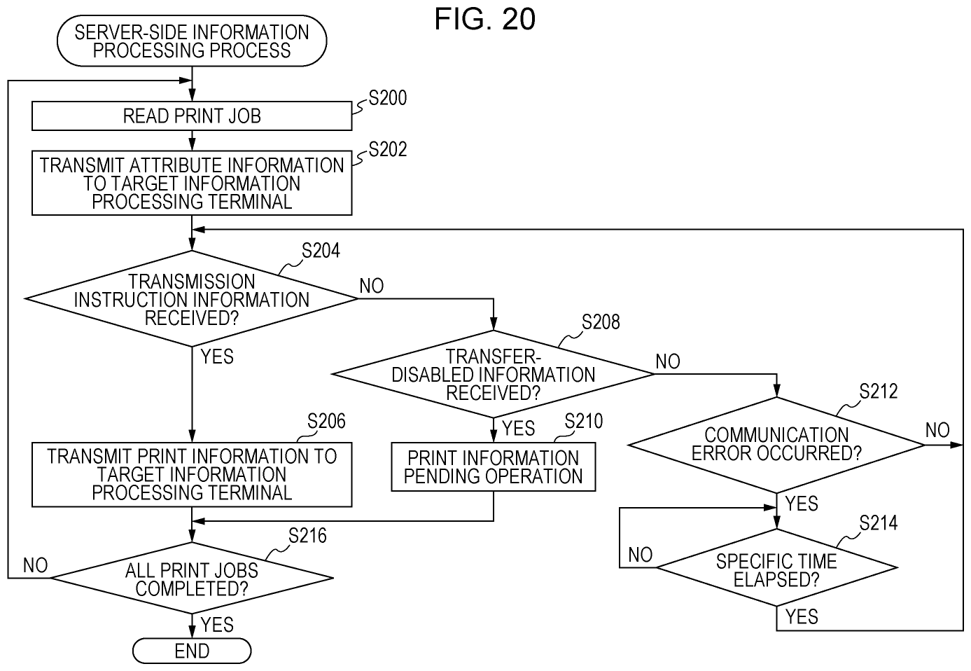

The function of the cloud server 10 that performs a server-side information processing process to transfer the registered print job to the information processing terminal 30 is described with reference to FIG. 20. FIG. 20 is a flowchart illustrating an example of the server-side information processing process of the exemplary embodiment of the disclosure. The CPU 11 in the cloud server 10 performs the server-side information processing process in FIG. 20 by executing the server-side information processing program 13A periodically every predetermined time duration (10 seconds in the exemplary embodiment).

In step S200 in FIG. 20, the CPU 11 reads one print job (hereinafter referred to as a “target job”) from the registered print jobs. In step S202, the CPU 11 extracts the attribute information of the read target job and then transmits the attribute information to the information processing terminal 30 serving as a transmission target of the target job. In this case, the CPU 11 reads from the authorized region information database 13B the region information corresponding to the user 70 of the information processing terminal 30 serving as the transmission target of the target job and then transmits the region information including the attribute information to the information processing terminal 30.

Upon receiving the attribute information, the information processing terminal 30 transmits, to the cloud server 10, information that instructs the print information responsive to the received attribute information to be transmitted (hereinafter referred to as “transmission instruction information”) or information indicating that the spooling of the print information is not accepted (hereinafter referred to as “transfer-disabled information”).

In step S204, the CPU 11 determines whether the transmission instruction information has been received from the information processing terminal 30 having transmitted the attribute information. If the yes path is followed, the process proceeds to step S206.

In step S206, the CPU 21 transmits the print information on the read target job to the information processing terminal 30 serving as the transmission source of the transmission instruction information and then the process proceeds to step S216.

If the no path is followed in step S204, the process proceeds to step S208. The CPU 21 determines whether the transfer-disabled information has been received from the information processing terminal 30 having transmitted the attribute information. If the yes path is followed in step S208, the CPU 21 proceeds to step S210.

In step S210, the CPU 21 transmits the print information corresponding to the transmitted attribute information until the end of the effective period included in the attribute information and then stays pending as a print information pending operation. The process then proceeds to step S216. The print information to the information processing terminal 30, the transmission of which is pending in the print information pending operation in step S210, is transmitted to the information processing terminal 30 by the cloud server 10 when a re-transfer instruction provided by the information processing terminal 30 is received.

If the no path is followed in step S208, the process proceeds to step S212. In step S212, the CPU 21 determines whether a communication error has occurred with the information processing terminal 30 having transmitted the attribute information. If the no path is followed in step S212, the process returns to step S204. If the yes path is followed in step S212, the process proceeds to step S214. The process returns to step S204 after the elapse of a specific time duration (10 seconds in the exemplary embodiment) in step S214.

In step S216, the CPU 21 determines whether the operations in steps S200 through S214 have been completed for all the registered print jobs. If the no path is followed in step S216, the process returns to step S200 or if the yes path is followed in step S216, the process ends the server-side information processing process.

If the operations in steps S200 through S216 are iterated, the CPU 21 handles as a target a print job that has not been processed yet.

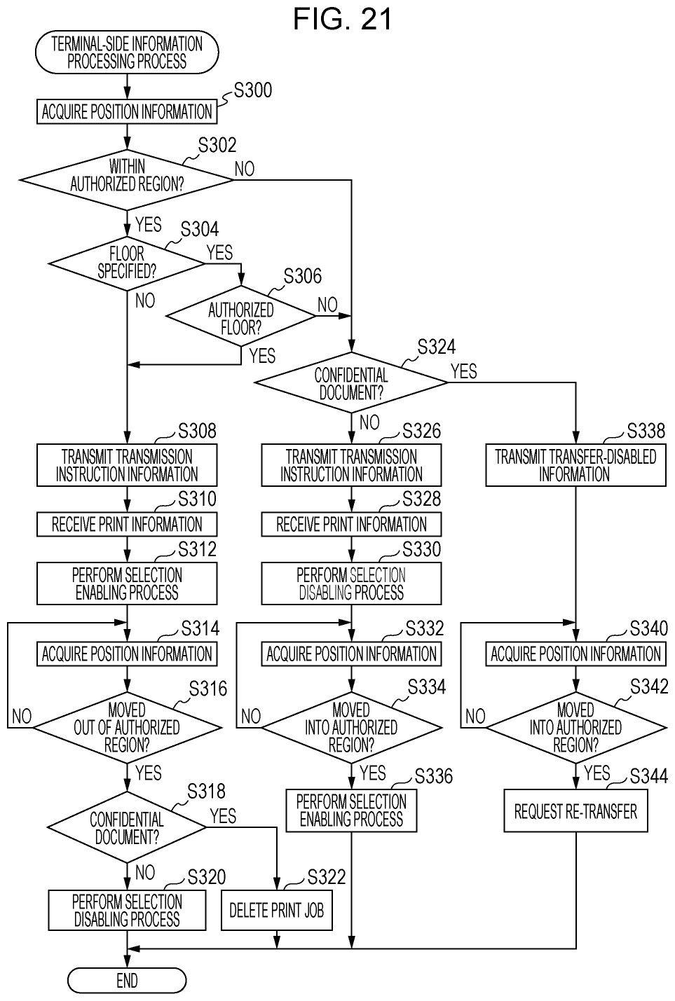

The function of the information processing terminal 30 that performs a terminal-side information processing process to spool the print job is described with reference to FIG. 21. FIG. 21 is a flowchart illustrating an example of the terminal-side information processing process of the exemplary embodiment. The CPU 31 in the information processing terminal 30 performs the terminal-side information processing process by executing the terminal-side information processing program 33A when the attribute information is received from the cloud server 10. For convenience of explanation, the following discussion focuses on the process of a single print job responsive to received attribute information.

In step S300 in FIG. 21, the CPU 31 acquires, from the position detector 39, position information indicating the position of the information processing terminal 30 in three-dimensional directions. In step S302, the CPU 31 determines whether the horizontal position of the information processing terminal 30 indicated by the acquired position information falls within the authorized region in the horizontal direction indicated by the region information included in the received attribute information. If the yes path is followed in step S302, the process proceeds to step S304. The operation in step S302 determines whether the information processing terminal 30 falls within the authorized region in the horizontal direction.

In the information processing system 1 of the exemplary embodiment, the information indicating the address is used as the authorized region indicated by the region information while the position information in the horizontal direction obtained by the position detector 39 indicates latitude and longitude. The CPU 31 thus performs the determination in step S302 by identifying the address of the position indicated by the latitude and longitude and determining whether the identified address matches an address within the authorized region.

In step S304, the CPU 31 determines whether the information indicating the floor number of the building is included in the authorized region indicated by the region information. If the no path is followed in step S304, the process proceeds to step S308 or if the yes path is followed in step S304, the process proceeds to step S306.

In step S306, the CPU 31 determines whether the information processing terminal 30 is within the authorized region in the height direction by determining whether the height position indicated by the acquired position information matches the floor number of the building. If the no path is followed in step S306, the process proceeds to step S324 or if the yes path is followed in step S306, the process proceeds to step S308.

In step S308, the CPU 31 transmits the transmission instruction information to the cloud server 10. In response to the reception of the transmission instruction information, the cloud server 10 transmits the print information responsive to the transmitted attribute information to the information processing terminal 30 as previously described. In step S310, the CPU 31 receives the print information transmitted from the cloud server 10.

In step S312, the CPU 31 produces a print job (hereinafter referred to as a “process target job”) using the received attribute information and print information and then stores the process target job on the storage 33. The CPU 31 then performs a selection enabling process that enables the user 70 to select on the information processing terminal 30 the process target job as a print target on the image forming apparatus 50.

According to the exemplary embodiment, the process target job is not grayed out on the print job list screen 35C in FIG. 13 in the selection enabling process. The disclosure is not limited to this setting.

In step S314, the CPU 31 acquires the position information in a similar manner as in the operation in step S300. In step S316, the CPU 31 determines, in accordance with the acquired position information, whether the information processing terminal 30 has moved out the authorized region (hereinafter referred to as a “process target region”). In steps S302 and S306, the information processing terminal 30 has determined whether the information processing terminal 30 itself is within the process target region. If the no path is followed in step S316, the CPU 31 returns to step S314. If the yes path is followed in step S316, the CPU 31 proceeds to step S318.

Through the operations in steps S314 and S316, the CPU 31 waits on standby until the information processing terminal 30 moves out of the process target region. During this time, the user 70 may perform the printing on the image forming apparatus 50 in accordance with the process target job.

In step S318, the CPU 31 references the confidential designation information in the received attribute information and then determines whether the print information included in the process target job indicates a confidential document. If the no path is followed in step S318, the process proceeds to step S320. In step S320, the CPU 31 performs a selection disabling process that causes the user 70 to be unable to select on the information processing terminal 30 the process target job as the print target on the image forming apparatus 50. The CPU 31 then ends the terminal-side information processing process.

According to the exemplary embodiment, the process target job is grayed out on the print job list screen 35C in FIG. 13 in the selection disabling process. The disclosure is not limited to this setting.

If the yes path is followed in step S318, the process proceeds to step S322. The CPU 31 deletes the process target job from the storage 33, notifies the user 70 that the process target job has been deleted, and ends the terminal-side information processing process. According to the exemplary embodiment, the notification to the user 70 in step S322 is performed by displaying the notification on the display 35 of the information processing terminal 30. The disclosure is not limited to this setting. For example, the notification to the user 70 may include a sound notification provided by a sound reproducing device (not illustrated) or a print notification provided by the image forming apparatus 50.

If the no path is followed in step S302, the CPU 31 determines that the information processing terminal 30 is outside the authorized region and proceeds to step S324. In step S324, the CPU 31 references the confidential designation information in the received attribute information and thus determines whether the print information responsive to the attribute information indicates a confidential document. If the no path is followed in step S324, the process proceeds to step S326.

In step S326, the CPU 31 transmits the transmission instruction information to the cloud server 10. In response to the reception of the transmission instruction information, the cloud server 10 transmits the print information responsive to the transmitted attribute information to the information processing terminal 30 as previously described. In step S328, the CPU 31 receives the print information transmitted from the cloud server 10.

In a similar manner as in the operation in step S312, the CPU 31 produces the process target job using the received attribute information and print information and stores the process target job on the storage 33 in step S330. In a similar manner as in the operation in step S320, the CPU 31 performs the selection disabling process that causes the process target job to be unselectable.

In a similar manner as in the operation in step S300, the CPU 31 acquires the position information in step S332. In a similar manner as in the operations in steps S302 through S306, the CPU 31 determines, in step S334 in accordance with the acquired position information, whether the information processing terminal 30 has moved into any authorized region. If the no path is followed in step S334, the CPU 31 returns to step S332. On the other hand, if the yes path is followed in step S334, the CPU 31 proceeds to step S336.

Through the operations in steps S332 and S334, the CPU 31 waits on standby until the information processing terminal 30 moves from outside into the authorized region.

In a similar manner as in the operation in step S312, the CPU 31 performs the selection enabling operation to cause the process target job to be selectable in step S336 and then ends the terminal-side information processing process.

If the yes path is followed in step S324, the CPU 31 determines that the print information responsive to the received attribute information indicates a confidential document and the CPU 31 proceeds to step S338. In step S338, the CPU 31 transmits the transfer-disabled information to the cloud server 10.

In a similar manner as in the operation in step S300, the CPU 31 acquires the position information in step S340. In a similar manner as in the operations in steps S302 through S306, the CPU 31 determines, in step S342 in accordance with the acquired position information, whether the information processing terminal 30 has moved into any authorized region. If the no path is followed in step S342, the CPU 31 returns to step S340. If the yes path is followed in step S342, the CPU 31 proceeds to step S344.

In step S344, the CPU 31 transmits an instruction to re-transfer the print information to the cloud server 10 and then ends the terminal-side information processing process.

Through the operations in steps S340 through S344, the CPU 31 waits on standby until the information processing terminal 30 moves from outside into the authorized region. The CPU 31 then instructs the cloud server 10 to re-transfer the print information in order to produce the process target job. As a result, the print information is received from the cloud server 10, the CPU 31 produces a print job in accordance with the received attribute information and print information, and registers the print job on the storage 33. The image forming apparatus 50 is thus able to print using the print job.

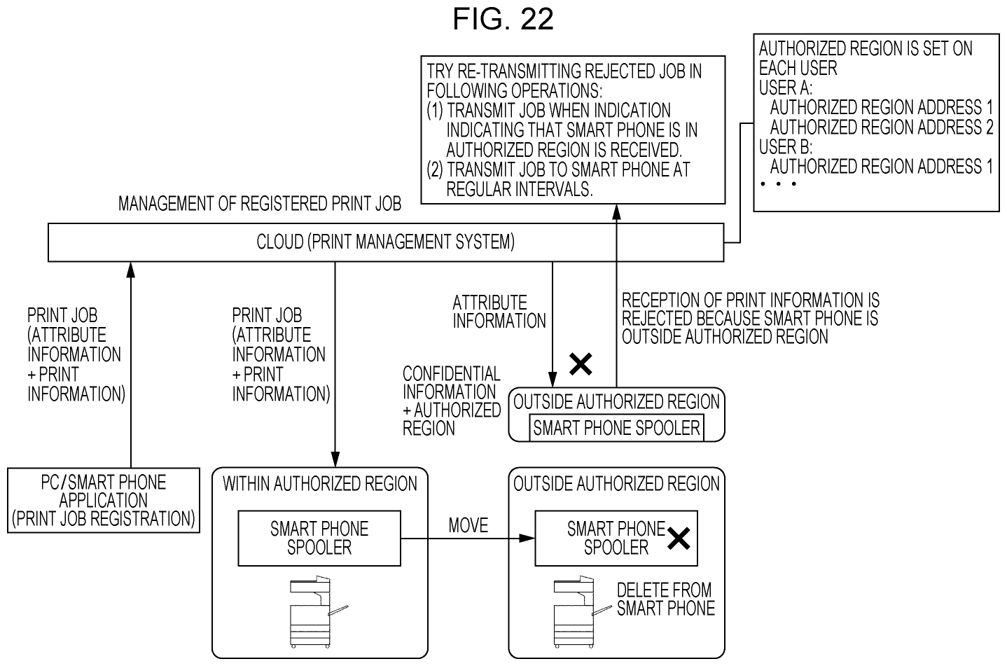

FIG. 22 schematically illustrates an example of an overall process flow of the information processing system 1 of the exemplary embodiment. Referring to FIG. 22, the client computer 20 is denoted by “PC.” and the information processing terminal 30 is denoted by “Smart phone.”

Referring to FIG. 22, the client computer 20 or the information processing terminal 30 registers the print job on the cloud server 10 in the information processing system 1 of the exemplary embodiment. If the information processing terminal 30 is present within an authorized region pre-registered in the registration process described above (the authorized region on each user in the exemplary embodiment), the corresponding print job is spooled on the information processing terminal 30. If the information processing terminal 30 is outside the authorized region, the information processing terminal 30 rejects the reception of the print information.

When the information processing terminal 30 has moved out of the authorized region, the spooled print job is deleted and the possibility that the information on the print job leaks to the outside may be reduced.

According to the exemplary embodiment, the region information indicating the authorized region is included in the attribute information on the print job and these pieces of information are then transmitted to the information processing terminal 30. The disclosure is not limited to this setting. For example, in another example, the information processing terminal 30 having received the attribute information may read and retrieve the region information on the user 70 from the authorized region information database 13B.

According to the exemplary embodiment, the information processing terminal 30 determines whether to receive the print information by determining whether the position of the information processing terminal 30 is within the authorized region. The disclosure is not limited to this setting. For example, in another example, the cloud server 10 acquires the position information from the information processing terminal 30 and determines in accordance with the position information whether the information processing terminal 30 is present within the authorized region. The cloud server 10 may thus determine whether to transmit the print information to the information processing terminal 30.

According to the exemplary embodiment, the authorized region information database 13B is registered on the cloud server 10. The disclosure is not limited to this setting. For example, the authorized region information database 13B may be registered on another apparatus that is accessible to the client computer 20, the information processing terminal 30, the image forming apparatus 50 or the cloud server 10.

In yet another example, part of the print information may be transferred when the information processing terminal 30 is still outside the authorized region and the remaining print information may be transferred when the information processing terminal 30 has moved into the authorized region. According to this example, the part of the print information is transferrable to the information processing terminal 30 that is outside the authorized region. The transfer time of the print information to the information processing terminal 30 may thus be shorter than the case in which all the print information is transferred at the time when the information processing terminal 30 moves in the authorized region.

The exemplary embodiment has been described. The scope of the disclosure is not limited to the scope of the described exemplary embodiment. A variety of modifications and variations may be possible in the exemplary embodiment without departing from the scope of the disclosure. The exemplary embodiment thus with such modifications and changes implemented therewithin may still fall within the scope of the disclosure.

The exemplary embodiment is not intended to limit the scope of the disclosure defined by the claims. All features described with reference to the exemplary embodiment are not necessarily used to form the disclosure. The exemplary embodiment includes a variety of phases of the disclosure and a combination of disclosed elements may form a variety of disclosures. If a subset of elements is deleted from all the elements illustrated with reference to the embodiment, a configuration with the subset deleted may form a disclosure as long as the configuration has an effect.

In the embodiment above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiments above, and may be changed.

The “system” typically includes multiple apparatuses in the exemplary embodiment but, alternatively, only a single apparatus may form the system.

According to the exemplary embodiment, each process is implemented by a software configuration when a computer executes the corresponding program. The disclosure is not limited to this method. For example, each process may be implemented by a hardware configuration or a combination of the software configuration and the hardware configuration.

The configurations of the cloud server 10, client computer 20, information processing terminal 30, and image forming apparatus 50 have been described for exemplary purposes only and an element may be deleted therefrom or a new element may be added thereto without departing from the scope of the disclosure.

The flow processes described with reference to the exemplary embodiment have been described for exemplary purposes only and a step may be deleted from the processes, a new step may be added to the processes, or the order of operations of the processes may be changed without departing from the scope of the disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system including:
one or more processors configured to:
   accept that a user registers print information serving as a print target, an information processing terminal serving as a transfer destination of the print information, and region information indicating an authorized region that permits the print information to be transmitted to the information processing terminal; and
   in transferring the registered print information to the registered information processing terminal, transfer the print information to the registered information processing terminal only if the registered information processing terminal is present within the authorized region indicated by the registered region information.
      (((2)))

In the information processing system according to (((1))), the processor is configured to delete the print information if the information processing terminal has moved out of the authorized region.

(((3)))

In the information processing system according to (((2))), the processor is configured to notify the user of the deletion of the print information if the print information has been deleted.

(((4)))

In the information processing system according to one of (((2))) and (((3))), the processor is configured to transfer again the print information to the information processing terminal if the information processing terminal moves into the authorized region after going out of the authorized region.

(((5)))

In the information processing system according to one of (((1))) through (((4))), the processor is configured to perform restriction of the authorized region on the information processing terminal only if the print information is information indicating confidential information.

(((6)))

In the information processing system according to one of (((1))) through (((5))), the processor is configured to receive the registration of the authorized region on a per user basis.

(((7)))

In the information processing system according to (((6))), the processor is configured to receive the registration of the authorized region on a per group basis with each group including a plurality of users.

(((8)))

In the information processing system according to one of (((1))) through (((7))), the authorized region is a region defined in three-dimensional directions.

What is claimed is:

1. An information processing system comprising:
one or more processors configured to:
accept that a user registers print information serving as a print target, an information processing terminal serving as a transfer destination of the print information, and region information indicating an authorized region that permits the print information to be transmitted to the information processing terminal; and
in transferring the registered print information to the registered information processing terminal, transfer the print information to the registered information processing terminal only if the registered information processing terminal is present within the authorized region indicated by the registered region information.

2. The information processing system according to claim 1, wherein the processor is configured to delete the print information if the information processing terminal has moved out of the authorized region.

3. The information processing system according to claim 2, wherein the processor is configured to notify the user of the deletion of the print information if the print information has been deleted.

4. The information processing system according to claim 2, wherein the processor is configured to transfer again the print information to the information processing terminal if the information processing terminal moves into the authorized region after going out of the authorized region.

5. The information processing system according to claim 3, wherein the processor is configured to transfer again the print information to the information processing terminal if the information processing terminal moves into the authorized region after going out of the authorized region.

6. The information processing system according to claim 1, wherein the processor is configured to perform restriction of the authorized region on the information processing terminal only if the print information is information indicating confidential information.

7. The information processing system according to claim 2, wherein the processor is configured to perform restriction of the authorized region on the information processing terminal only if the print information is information indicating confidential information.

8. The information processing system according to claim 1, wherein the processor is configured to receive the registration of the authorized region on a per user basis.

9. The information processing system according to claim 2, wherein the processor is configured to receive the registration of the authorized region on a per user basis.

10. The information processing system according to claim 8, wherein the processor is configured to receive the registration of the authorized region on a per group basis with each group including a plurality of users.

11. The information processing system according to claim 9, wherein the processor is configured to receive the registration of the authorized region on a per group basis with each group including a plurality of users.

12. The information processing system according to claim 1, wherein the authorized region is a region defined in three-dimensional directions.

13. The information processing system according to claim 2, wherein the authorized region is a region defined in three-dimensional directions.

14. A non-transitory computer readable medium storing a program causing a computer to execute a process for processing information, the process comprising:
accepting that a user registers print information serving as a print target, an information processing terminal serving as a transfer destination of the print information, and region information indicating an authorized region that permits the print information to be transmitted to the information processing terminal; and
in transferring the registered print information to the registered information processing terminal, transferring the print information to the registered information processing terminal only if the registered information processing terminal is present within the authorized region indicated by the registered region information.

15. An information processing method comprising:
accepting that a user registers print information serving as a print target, an information processing terminal serving as a transfer destination of the print information, and region information indicating an authorized region that permits the print information to be transmitted to the information processing terminal; and
in transferring the registered print information to the registered information processing terminal, transferring the print information to the registered information processing terminal only if the registered information processing terminal is present within the authorized region indicated by the registered region information.
